(19) United States
(12) Patent Application Publication
(10) Pub. No.: US 2014/0066289 A1
(43) Pub. Date: Mar. 6, 2014

(54) COMPOSITE ARTICLE FOR USE AS SELF-CLEANING MATERIAL

(71) Applicants: Katherine M. Sahlin, Old Orchard Beach, ME (US); James R. Greno, Williamsville, NY (US); Michael P. Cushman, Williamstown, MA (US); Robert C. Hobbs, Merrimack, NH (US); James M. McMartin, Hooksett, NH (US)

(72) Inventors: Katherine M. Sahlin, Old Orchard Beach, ME (US); James R. Greno, Williamsville, NY (US); Michael P. Cushman, Williamstown, MA (US); Robert C. Hobbs, Merrimack, NH (US); James M. McMartin, Hooksett, NH (US)

(73) Assignee: SAINT-GOBAIN PERFORMANCE PLASTICS CORPORATION, Aurora, OH (US)

(21) Appl. No.: 13/602,189

(22) Filed: Sep. 2, 2012

(51) Int. Cl. B01J 31/38; B01J 31/06

(52) U.S. Cl. 502/159

(57) ABSTRACT

A composite article includes a core layer and an upper layer overlying the core layer. The upper layer is made of perfluoroalkoxy polymer (PFA) and a photocatalytic material (PM), wherein the PM defines at least about 25% of a total area of an exterior surface of the upper layer.

### BACKGROUND

1. Field of the Disclosure

The following relates to composite articles, and particularly composite articles incorporating photocatalyst materials for self-cleaning materials.

2. Description of the Related Art

Building and technical materials are used in various environments for various purposes, including for examples large buildings, gymnasiums, stadiums, multipurpose halls, technical assemblies, including for example, enclosing communications devices. In many circumstances, these materials must be capable of withstanding the effects of harsh environmental conditions (sun, heavy rain, ice, blowing sand, extreme temperature, high winds, etc.). The fabrics of many of these materials are coated with a material having the purpose of resisting environmental elements, maintaining physical properties (including strength and interply adhesions), or of otherwise making the material more functional for longer durations.

Generally, the coating materials incorporate a fluoropolymer layer as a barrier against harmful materials and to improve the release of harmful materials from depositing on the underlying material, which could compromise the integrity or servicability of the underlying material. Materials with hydrophobic surfaces prevent rainwater from sheeting over the material, allowing it to bead and run off easily. Water on the surface of the composite material reduces the RF transmission abilities of the composite. Accumulations of dirt and other airborne/wind-blown particulates can reduce the ability of even fluoropolymer surfaces to shed water. Non-fluoropolymer materials used in RF applications require periodic cleaning and painting to maintain their surface, and this maintenance is generally done yearly.

However, the industry continues to demand improved materials for use with various building and technical materials.

### SUMMARY

According to one aspect, a composite article includes a core layer, and an upper layer overlying the core layer, wherein the upper layer having a perfluoroalkoxy polymer (PFA) and a photocatalytic material (PM), and wherein the upper layer has at least about a 2% greater concentration per unit area of PM at an exterior surface of the upper layer compared to a conventional photoreactive composite material.

According to another aspect, a composite article includes a core layer and an upper layer overlying the core layer. The upper layer having a perfluoroalkoxy polymer (PFA) and a photocatalytic material (PM), wherein the PM defines at least about 25% of a total area of an exterior surface of the upper layer.

In yet another aspect, a composite article includes a core layer and an upper layer overlying the core layer. The upper layer having a perfluoroalkoxy polymer (PFA) and a photocatalytic material (PM). The PM consists essentially of titanium dioxide (TiO₂) particles, wherein the titanium dioxide particles define at least about 25% of a total area of an exterior surface of the upper layer.

In still another aspect, a composite article includes a core layer and an upper layer overlying the core layer. The upper layer having a fluoropolymer material and a photocatalytic material (PM). Moreover, the upper layer has an increased photoreactivity of at least about 2% as compared to the photoreactivity of a conventional photoreactive composite material.

According to one aspect, a composite article includes a core layer, and an upper layer overlying the core layer, wherein the upper layer having a perfluoroalkoxy polymer (PFA) and a photocatalytic material (PM). Moreover, the upper layer has an increased photoreactivity of at least about 2% as compared to the photoreactivity of a conventional photoreactive composite material.

For at least one aspect, a composite article includes a core layer having a plurality of films bonded to each other, wherein at least one of the films of the plurality of films comprises a filler. The composite article also includes an upper layer overlying the core layer. Moreover, the upper layer has an increased photoreactivity of at least about 2% as compared to the photoreactivity of a conventional photoreactive composite material.

For another aspect, a composite article includes a core layer having a plurality of films bonded to each other, wherein at least one of the films of the plurality of films comprises a filler. The composite article also includes an upper layer overlying the core layer. The upper layer includes perfluoroalkoxy polymer (PFA) and a photocatalytic material (PM). Moreover, the upper layer has an increased photoreactivity of at least about 2% as compared to the photoreactivity of a conventional photoreactive composite material.

According to another aspect, a composite structure including a base structure and a composite article overlying the base structure, wherein the composite article includes a core layer and an upper layer overlying the core layer. The upper layer having a perfluoroalkoxy polymer (PFA) and a photocatalytic material (PM). The PM defines at least about 25% of a total area of an upper surface of the upper layer.

In still another aspect, a transmitter/receiver structure includes a transmitter/receiver assembly and a cover overlying the transmitter/receiver assembly. The cover includes a core layer and an upper layer overlying the core layer. The upper layer having a perfluoroalkoxy polymer (PFA) and a photocatalytic material (PM). Furthermore, the PM defines at least about 25% of a total area of an upper surface of the upper layer.

According to yet another aspect, a transmitter/receiver structure includes a transmitter/receiver assembly and a cover overlying the transmitter/receiver assembly. The cover includes a core layer and an upper layer overlying the core layer. The upper layer having a fluoropolymer material and a photocatalytic material (PM). Moreover, the upper layer has an increased photoreactivity of at least about 2% as compared to the photoreactivity of a conventional photoreactive composite material.

In still another aspect, a composite material having a composite sheet material including a first composite article and a second composite article bonded to the first composite article at a joint region defined by a melt-flowed seam. The first and second composite articles include a core layer and an upper layer overlying the core layer, wherein the upper layer comprises perfluoroalkoxy polymer (PFA) and a photocatalytic material (PM), and wherein the PM defines at least about 25% of a total area of an exterior surface of the upper layer.

According to one aspect, a composite material includes a composite sheet material having a first composite article and a second composite article bonded to the first composite article at a joint region defined by a melt-flowed seam. The first and second composite articles include a core layer and an upper layer overlying the core layer, wherein the upper layer comprises a fluoropolymer material and a photocatalytic material (PM), the upper layer comprising a photoreactivity of at least about 20 .as measured according to a dye test.

For another aspect, a composite article includes a core layer and an upper layer overlying the core layer. The upper layer has a fluoropolymer material and a photocatalytic material (PM), the upper layer including a photoreactivity of at least about 20 as measured according to a dye test.

### BRIEF DESCRIPTION OF THE DRAWINGS

The present disclosure may be better understood, and its numerous features and advantages made apparent to those skilled in the art by referencing the accompanying drawings.

FIG. 1 includes a cross-sectional illustration of a composite article in accordance with an embodiment.

FIG. 2 includes a cross-sectional illustration of a portion of a composite article in accordance with an embodiment.

FIG. 3 includes a cross-sectional illustration of a composite structure in accordance with an embodiment.

FIG. 4 includes a cross-sectional illustration of a composite structure in accordance with an embodiment.

FIG. 5 includes an illustration of a transmitter/receiver structure in accordance with an embodiment.

FIG. 6 includes a perspective view illustration of a composite sheet material according to an embodiment.

FIGS. 7a and 7b includes Scanning Electron Microscope (“SEM”) images of a composite structure in accordance with an embodiment

### DETAILED DESCRIPTION

The following is directed to composite articles for use with building materials and technical materials, including for example, applications pertaining to electronics, optics, communications, architecture, construction, and the like. The composite articles of the embodiments herein have self-cleaning characteristics and facilitate extended lifetime and reduced maintenance of the articles with which they are used.

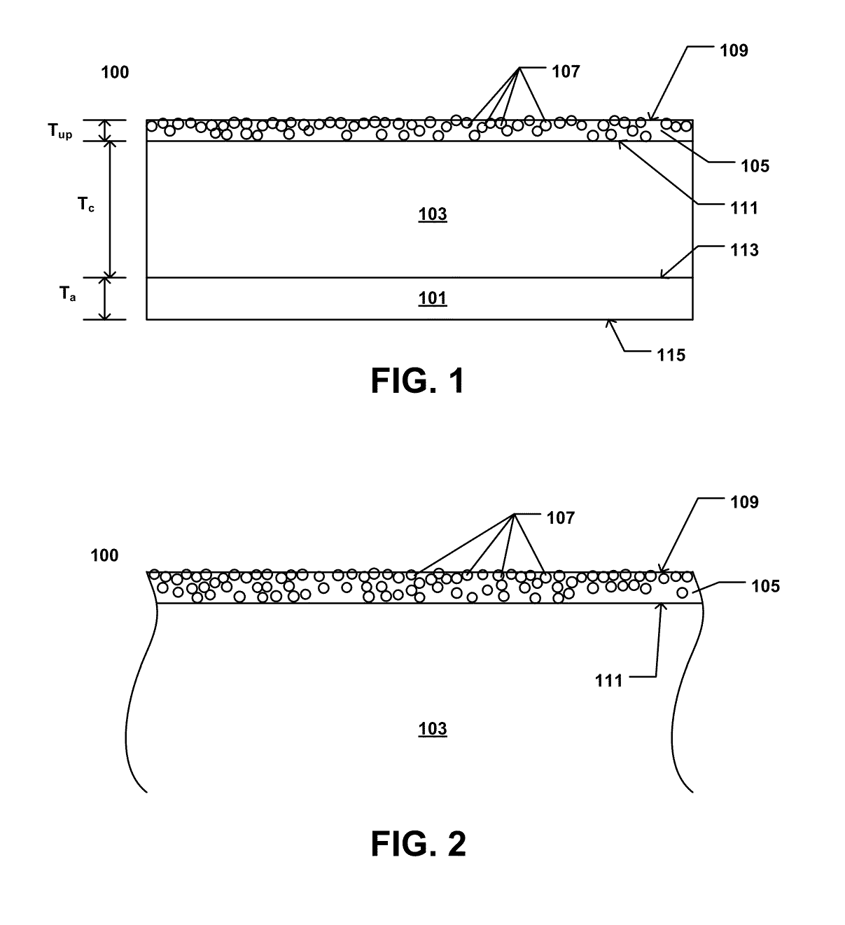

FIG. 1 includes a cross-sectional illustration of a composite article in accordance with an embodiment. As illustrated, the composite article 100 can include a plurality of layers. The composite article 100 can include an adhesive layer 101, a core layer 103 overlying the adhesive layer 101, and an upper layer 105 overlying the core layer 103. As further illustrated, the composite article 100 can be formed such that the adhesive layer 101 is in direct contact with the core layer 103 at interface 113. In certain embodiments, the core layer 103 can be directly bonded to the adhesive layer 101 at the interface 113 between the layers 101 and 103. Furthermore, the composite article 100 can be formed such that the upper layer 105 is in direct contact with the core layer 103 at interface 111. In some embodiments, the upper layer 105 can be directly bonded to the core layer 103 at the interface 111.

As further illustrated, the composite article 100 can include a base surface 115 defined by a major surface of the adhesive layer 101. It is this surface that can be used for attachment of the composite article 100 to another article. The composite article 100 can include an exterior surface 109 defined by an uppermost surface of the upper layer 105. In accordance with an embodiment, the upper layer 105 may be formed such that it includes a photocatalytic material 107 disposed within the volume of material forming the upper layer 105.

In particular reference to the adhesive layer 101, the adhesive layer 101 can be formed to facilitate adhesion of the composite article 100 to an underlying structure, such as a base structure. As such, the composite article 100 can be utilized as an overlay or coating on various materials in various applications. Furthermore, the adhesive layer 101 may be formed of a plurality of layers bonded together. Such a layer may be formed through a casting process, as described in more detail herein.

In accordance with an embodiment, the adhesive layer 101 can include a polymer material. More particularly, the adhesive layer can include a fluoropolymer material. For example, certain suitable fluoropolymer materials can include materials such as fluorine-containing homopolymers, copolymers and terpolymers of tetrahaloethylenes, vinyl fluoride, vinylidene fluoride, hexafluoropropylene, perfluoroalkyl vinyl ethers, ethylene and propylene. In more particular instances, the fluoropolymer can include polyvinylfluoride (PVF), polyvinylidene fluoride (PVDF), polytetrafluoroethylene (PTFE), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), perfluorinated elastomer (FFPM/FFKM), perfluoropolyether (PFPE), tetrafluoroethylene, hexafluoropropylene and vinylidene fluoride terpolymer (THV), and a combination thereof.

In particular instances, the adhesive layer 101 can be formed such that it can include a combination of polymer materials. That is, a blend of polymer materials can be used, for example a fluoropolymer material and an elastomer. In particular instances, the adhesive layer 101 can be formed to include a blend of Fluorinated Ethylene propylene (FEP) and an elastomer, such as perfluoronated elastomer (FFPM/FFKM).

In more particular instances, a particular type of fluoropolymer may be used. For example, an unsintered PTFE material may be used. Unsintered PTFE has the ability to form fibrils when sheared. When two unsintered PTFE surfaces are sheared against each other, the fibrils intertangle, forming a mechanical bond of sufficient strength as to allow for subsequent sintering of the article. After sintering the two unsintered PTFE layers are indistinguishable and form a single sintered PTFE layer.

According to one embodiment, the adhesive layer 101 can include a blend of FEP and a perfluoronated elastomer. The blend facilitates an adhesive characteristic despite being a fluoropolymer material, while still providing suitable strength and material characteristics for bonding to the core layer 103.

The composite article 100 can be formed such that the adhesive layer 101 has a particular average thickness (Tₐ). The adhesive layer 101 may be formed such that it has an average thickness (Tₐ) that is significantly less than the average thickness of the core layer 103 (T_{c}). In accordance with one embodiment, the adhesive layer 101 can be formed such that it comprises an average thickness within a range between about 0.1 micron and about 0.05 mm.

The composite article 100 can be formed such that it includes a core layer 103. The core layer 103 can provide certain mechanical, aesthetic, and electrical properties suitable for the composite article 100. In certain instances, the core layer 103 can be formed from a plurality of layers. It will be appreciated that the core layer 103 may be formed through a particular dip casting method. Details on one particular forming method are provided herein.

In accordance with an embodiment, the core layer 103 can include a polymer material, and more particularly a fluoropolymer material. Suitable fluoropolymer materials can include materials such as fluorine-containing homopolymers, copolymers and terpolymers of tetrahaloethylenes, vinyl fluoride, vinylidene fluoride, hexafluoropropylene, perfluoroalkyl vinyl ethers, ethylene and propylene. In more particular instances, the fluoropolymer can include polyvinylfluoride (PVF), polyvinylidene fluoride (PVDF), polytetrafluoroethylene (PTFE), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), perfluorinated elastomer (FFPM/FFKM), perfluoropolyether (PFPE), tetrafluoroethylene, hexafluoropropylene and vinylidene fluoride terpolymer (THV), and a combination thereof. In particular, the core layer 103 can be formed of a fluoropolymer material, particularly polytetrafluoroethylene (PTFE). In one particular instance, the core layer 103 can be formed such that it consists essentially of polytetrafluoroethylene (PTFE).

Additionally, the core layer 103 can be formed such that it incorporates fillers. Some suitable fillers can include carbon, mica, metal oxides, metal bismuths, silicates, PEEK, PPS, and elastomers The filler materials can be provided to enhance certain aspects of the composite article 100 including transmission or absorption of certain wave lengths of radiation, pigmentation of the composite article 100 as well as features facilitating certain electronic properties (e.g. dielectric properties), optical properties, and a combination thereof.

Notably, the core layer 103 can be a continuous layer of material. That is, the core layer 103 is not necessarily a fabric or woven article but a layer of continuous material of substantially consistent thickness. That is, the core layer 103 may have very little porosity, such as less than 1 vol % of the total volume of the core layer 103. The core layer 103 does not necessarily have openings extending through its thickness. In fact, in certain instance, the core layer 103 may be utilized as a dense, low-permeability layer.

In accordance with an embodiment, the core layer 103 can be formed to have an average thickness (T_{C}) that is significantly greater than an average thickness (Tₐ) of the of the adhesive layer 101 or the average thickness (Tᵤₚ) of the upper layer 105. In particular instances, the core layer can have an average thickness (T_{c}) within a range between about 1 micron and about 0.1 mm.

The upper layer 105 can be formed to overly the core layer 103. Furthermore, the upper layer 105 can incorporate a combination of materials including a polymer and a photocatalytic material 107. In some instances, depending upon the weight percent of the constituent components, the upper layer 105 can include a mixture of polymer material and photocatalytic material 107. In particular instances, the photocatalytic material 107 can be generally held in place by a matrix of polymer material. Alternatively, the upper layer 105, and more particularly, portions of the upper layer 105, can be formed such that the photocatalytic material 107 is present in a majority amount and can form a matrix and the polymer material is impregnating the matrix of photocatalytic material (i.e., extending into pores of the network of photocatalytic material).

FIG. 2 includes a cross-sectional view of a portion of the composite article 100 in accordance with an embodiment. In accordance with an embodiment, the upper layer 105 can be formed to include a combination of polymer material and photocatalytic material 107. In certain instances, the upper layer 105 can include at least about 25 wt % photocatalytic material for the total weight of the upper layer 105. In other instances, the amount of photocatalytic material within the upper layer can be greater, such as at least about 28 wt %, at least about 30 wt %, at least about 33 wt %, at least about 35 wt %, at least about 38 wt %, at least about 40 wt %, at least about 42 wt %, at least about 45 wt %, at least about 47 wt %, at least about 50 wt %, at least about 52 wt %, at least about 55 wt %, at least about 57 wt %, at least about 60 wt %, at least about 62 wt %, or even at least about 65 wt % for the total weight of the upper layer 105. Alternatively, in certain instances, the upper layer 105 may be formed such that it contains not greater than about 90 wt %, not greater than about 85 wt %, not greater than about 80 wt %, not greater than about 75 wt %, not greater than about 70 wt %, not greater than about 65 wt %, not greater than about 60 wt %, not greater than about 55 wt %, not greater than about 50 wt %, not greater than about 45 wt %, not greater than about 40 wt %, not greater than about 35 wt % photocatalytic material for the total weight of the upper layer 105. It will be appreciated that depending upon the content of the photocatalytic material within the upper layer 105, the balance of the weight percent of material making up the upper layer 105 can include the polymer material.

In accordance with an embodiment, the polymer material within the upper layer 105 can include a fluoropolymer. Suitable fluoropolymer materials can include materials such as fluorine-containing homopolymers, copolymers and terpolymers of tetrahaloethylenes, vinyl fluoride, vinylidene fluoride, hexafluoropropylene, perfluoroalkyl vinyl ethers, ethylene and propylene. In more particular instances, the fluoropolymer can include polyvinylfluoride (PVF), polyvinylidene fluoride (PVDF), polytetrafluoroethylene (PTFE), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), perfluorinated elastomer (FFPM/FFKM), perfluoropolyether (PFPE), tetrafluoroethylene, hexafluoropropylene and vinylidene fluoride terpolymer (THV), and a combination thereof. In one particular embodiment, the polymer material within the upper layer 105 includes perfluoroalkoxy polymer (PFA). In certain exemplary composite articles 100, the upper layer 105 includes a polymer consisting essentially of perfluoroalkoxy polymer (PFA). In accordance with another embodiment, the upper layer 105 is formed such that it consists essentially of PFA and a photocatalytic material.

The photocatalytic material 107 can be present at the exterior surface 109 in particularly effective concentrations. Photocatalytic material is only effective as long as it is exposed, that is present at and defining a portion of the exterior surface 109. Photocatalytic material buried within the volume of the polymer material forming the upper layer is rendered ineffective. The methods of forming the composite material, which are described herein, facilitate placement of effective concentrations of photocatalytic material at the exterior surface 109 of the upper layer 105.

In certain embodiments, a significant content of the photocatalytic material present within the upper layer 105 can be present at the exterior surface 109 of the upper layer 105. For example, in one embodiment, at least 10% of the total content of the photocatalytic material 107 present within the upper layer 105 intersects and defines at least a portion of the exterior surface 109 of the upper layer 105. In fact, in particular instances, at least about 15%, such as at least about 18%, at least about 20%, at least about 22%, at least about 25%, at least about 28%, at least about 30%, at least about 35%, at least about 40%, at least about 45%, or even about 50% of the total content of photocatalytic material 107 present within the upper layer 105 can be present at the exterior surface 109 of the upper layer 105. Still, in one non-limiting embodiment, not greater than about 90%, not greater than about 80%, not greater than about 70%, not greater than about 60%, not greater than about 50%, not greater than about 40% of the total content of photocatalytic material 107 present within the upper layer 105 can be present at the exterior surface 109 of the upper layer 105.

In one embodiment, the exterior surface 109 can be formed such that at least about 25% of the total area of the exterior surface 109 is defined by photocatalytic material 107. In another instance, the photocatalytic material can define a greater percentage of the total area of the exterior surface 109, such as least about 30%, at least about 32%, at least about 35%, at least about 37%, at least about 40%, at least about 42%, at least about 45%, at least about 47%, at least about 50%, at least about 52%, at least about 55%, at least about 57%, at least about 60%, at least about 62%, or even at least about 65% of the total surface area of the exterior surface 109 of the upper layer 105. Still, in particular instances, the photocatalytic material 107 can define not greater than about 99%, not greater than about 95%, not greater than about 90%, not greater than about 85%, or even not greater than about 80% of the total area of the exterior surface 109 of the upper layer 105.

In accordance with an embodiment, the upper layer can be formed such that it comprises at least about 2% greater concentration per unit area of photocatalytic material at the exterior surface 109 of the upper layer 105 as compared to a conventional photoreactive composite material. The concentration of photocatalytic material at the exterior surface 109 is measured by the concentration of photocatalytic material intersecting and exposed at the exterior surface 109. Notably, an exemplary conventional photoreactive composite material includes SHEERFILL® EverClean material, available from Saint-Gobain Performance Plastics, Inc, which includes an upper layer of PTFE and titanium oxide photocatalytic material on a coated, fabric core layer.

In other instances, the total concentration of photocatalytic material at the exterior surface can be at least 4% greater concentration per unit area as compared to the conventional photoreactive composite material. In yet another embodiment, the composite article 100 can be formed such that the exterior surface 109 comprises at least about a 6% greater concentration, such as at least about an 8% greater concentration, at least about a 10% greater concentration, at least about a 12% greater concentration, at least about a 15% greater concentration, at least about a 18% greater concentration, or even at least about a 20% greater concentration of photocatalytic material as compared to the concentration of catalytic material present at an exterior surface of the conventional photoreactive composite material. Still, in particular instances, the upper layer 105 can be formed such that the exterior surface 109 comprises not greater than about 99%, such as not greater than about 90%, not greater than about 80%, or even not greater than about 70% greater concentration per unit area of photocatalytic material as compared to the photocatalytic material present at the exterior surface of the conventional photoreactive composite material.

A preferred method to measure the amount of photocatalytic material at the surface of the material can include utilization of scanning electron microscope or other optical magnification device for observation testing.

A suitable equation for calculating the percent different in photocatalytic material at the exterior surface (PMext %) of a new composite article as compared to the amount of photocatalytic material at the exterior surface of the conventional product can be PMext %=[(PMn−PMc)]/PMc]×100%. PMn is the average value of photocatalytic material (e.g., particles) identified at the exterior surface of a sample using the observation test above and PMc is the average value of photocatalytic material (e.g., particles) identified at the exterior surface using the observation test above.

The exterior surface 109 of the upper layer 105 can have a particularly smooth average surface roughness (Rₐ), which can be measured using optical techniques or surface profilometer. In fact, the average surface roughness of the exterior surface can be at least about 2% less as compared to the average surface roughness of a conventional photoreactive composite material, such as the SHEERFILL® EverClean material, available from Saint-Gobain Performance Plastics, Inc, which includes an upper layer of PTFE and titanium oxide photocatalytic material on a coated fabric core layer. Notably, the forming process facilitates formation of a smooth and uniform upper layer 105, which also facilitates effective placement of the photocatalytic material at the exterior surface 109. According to another embodiment, the average surface roughness of the exterior surface can be at least about 4% less, such as at least about 6% less, at least about 8% less, at least about 10% less, at least about 12% less, at least about 15% less, at least about 25% less, at least about 40% less, or even at least about 50% less as compared to the average surface roughness (Rₐ) of the conventional photoreactive composite material.

A suitable equation for calculating the percent different in surface roughness (Rₐ %) between the new composite article and the conventional product can be Rₐ %=[(Rₐc−Rₐn)]/Rₐc]×100%. Rₐn is the average surface roughness (Ra) of the exterior surface 109 of the new composite article and Rₐc is the average surface roughness of the exterior surface of the conventional product.

In accordance with an embodiment, the photocatalytic material 107 can include a photo semiconductive material that is capable of initiating a photo-redox reaction when exposed to radiation within a range extending over the visible light and ultraviolet portions of the electromagnetic spectrum. In accordance with an embodiment, the photocatalytic material 107 can include an oxide. Some suitable oxides can include metal oxides incorporating certain transition metal oxide components such as titanium oxide, zinc oxide, strontium oxide, tungsten oxide, and a combination thereof. In accordance with a particular embodiment, the photocatalytic material 107 comprises titanium dioxide (TiO₂), and more particularly may consist essentially of titanium dioxide (TiO₂). For certain embodiments, the titanium dioxide may be anastase-phase titanium dioxide.

In one embodiment, the photocatalytic material can be a particulate material. The particulate material can have a certain morphology, including for example, elongated, needle-like, platelet, irregular, rounded, and a combination thereof. Furthermore, the photocatalytic material 107 can be a particulate material having an average particle size that is sub-micron. In some instances, the photocatalytic material can be a particulate material having an average particle size that is approximately nano-scale. For example, the average particle size of the particulate photocatalytic material 107 can be not greater than about 1 micron, such as not greater than about 0.5 microns, not greater than about 0.1 microns, not greater than about 0.08 microns, not greater than about 0.05 microns, not greater than about 0.03 microns, or even not greater than about 0.01 microns.

In accordance with an embodiment, the upper layer 105 can be formed such that it has an average thickness (Tᵤₚ) that is within a range between about 25 times and about 1000 times, such as within a range between about 25 times and about 500 times, or even within a range between about 100 times and about 500 times the average particle size of the particulate photocatalytic material. Formation of a particularly thin and smooth upper layer 105 can facilitate placement of the photocatalytic material at the exterior surface 109.

In one embodiment, the upper layer 105 can be formed to have an average thickness (Tᵤₚ) that is significantly less than the average thickness of the core layer 103 (T_{c}). In particular instances, the upper layer 105 can have an average thickness (Tᵤₚ) that is within a range between about 0.01 micron and about 0.05 mm.

The upper layer 105 may be formed such that it is essentially free of particular materials. For example, in one embodiment, the upper layer 105 can be formed such that it is essentially of polytetrafluoroethylene (PTFE). In other embodiments, the upper layer 105 can be formed such that it is essentially free of fluorinated ethylene-propylene (FEP). In other embodiments, the upper layer 105 can be formed such that it is essentially free of polyethylenetetrafluoroethylene (ETFE).

In accordance with another embodiment, the composite article 100 can be formed such that the upper layer comprises an increased photoreactivity as compared to the photoreactivity of a conventional photoreactive composite material. One exemplary conventional photoreactive composite material includes SHEERFILL® EverClean material, available from Saint-Gobain Performance Plastics, Inc, wherein the upper layer of the dip coated woven fabric composite has titanium dioxide particulate material imbedded in the layer as the photocatalytic material.

The photoreactivity of a photoreactive composite material can be measured through a dye test generally based upon the standardized test JIS R 1703-2, which measures the activity level by measuring the decomposition activity of methylene blue dye in a sample. The resulting properties provide the decomposition activity index (DAI), which is the amount of methylene blue dye decomposing per volume and minute (unit: micromol/L/min). In one embodiment, the DAI can be at least about 3 μmol/min, such as at least about 5 μmol/min, at least about 8 μmol/min, or even at least about 10 μmol/min. In another embodiment, the DAI is not greater than about 100 μmol/min, such as not greater than about 50 μmol/min, or even not greater than about 30 μmol/min. In a particular embodiment the DAI is at least about 12 μmol/min and not greater than about 20 μmol/min.

The dye only attaches to the photocatalytic material (e.g., TiO₂) at the exterior surface 109 of the upper layer 105. As such, light of a particular wavelength can be directed to the surface prior to exposure of a sample of composite material to the dye, and again after exposure. Particular process controls for conducting the measurement include a concentration of methylene blue dye solution of 0.20 mmol/L, a specimen size of the composite article, or at least the upper layer of the composite article, of 1.75×2.75 inches. The sample can be soaked in the solution for 10 minutes. After which, the ΔE*_{ab} of the material can be calculated using the equation: ΔE*_{ab}=[(ΔL*)²+(Δa*)²+(Δb*)²]^{1/2}, wherein ΔL*, Δa*, Δb* represents the changes in the individual color coordinates defining a CIELab colorspace. At least three individual measurements are conducted at three random locations across the surface of the sample. The measured results are used to calculate ΔE*_{ab} and the values are average to determine the average ΔE*_{ab} for the sample.

According to one particular embodiment, the composite article of the embodiments herein comprise a photoreactivity, as measured by average ΔE*_{ab}, of at least about 20. In other embodiments, the photoreactivity is at least about 21, such as at least about 22, at least about 23, or even at least about 24. In particular instances, the photoreactivity may be not greater than about 60, such as not greater than about 55, or not greater than about 50.

In accordance with another embodiment, the increased photoreactivity of the upper layer 105 of the composite article 100 can be an increase of at least about 2%, such as at least about 4%, at least about 6%, at least about 8%, at least about 10%, at least about 12%, at least about 15%, at least about 18%, at least about 20%, at least about 25%, at least about 30%, or even at least about 40% as compared to a photoreactivity of the conventional photoreactive composite material. Still, the increased photoreactivity may be not greater than about 150%, such as not greater than about 125%, or even not greater than about 100%, as compared to the photoreactivity of the conventional product. A suitable equation for comparing the percent different in photoreactivity of a new composite article as compared to the conventional product can be PR %=[(PRn−PRc)]/PRc]×100%, wherein PRn is the photoreactivity (i.e., average ΔE*_{ab}) of the new composite material and PRc is the photoreactivity (i.e., average ΔE*_{ab}) of the conventional product.

With regard to the method of forming the composite article 100, certain processing techniques can be used to facilitate the formation of the composite article 100 having the features described herein. In one exemplary process, the composite article can be formed through a dip casting process, such as one generally described in U.S. Pat. No. 5,075,065. The dip casting process can utilize a carrier belt, which may be formed of a polyimide material. The carrier belt can be passed through a particular dispersion of material that contains components intended to coat the carrier belt and form a thin layer of material on the carrier belt. After coating the carrier belt with a thin layer of material, the material may undergo further processing (e.g., sintering) to change the mechanical and or chemical properties of the thin layer deposited thereon. The dip casting process can be repeated as many times as necessary through various dispersions to create many layers of the same material or a layered composite comprising a series of different layers.

In accordance with an embodiment, the process of forming the composite article 100 can be initiated by passing the carrier belt through a dispersion comprising a high concentration of photocatalytic material. In particular instances, the dispersion can include a slurry of titanium oxide particles in an amount within a range between about 25 wt % and about 65 wt %, and more particularly within a range between about 30 wt % and about 45 wt % for the total weight of the slurry within the dispersion. Formation of this initial layer of photocatalytic material can facilitate the formation of a composite article having an exterior surface 109 of the upper layer 105, wherein a high concentration of photocatalytic material can be present at the exterior surface 109 of the upper layer 105. While the mechanics are not entirely understood, the formation of the upper layer first, and particularly the formation of a thin layer of material having a high concentration of photocatalytic material against a smooth surface (i.e., the carrier belt), and the fact that the upper layer is then maintained against the belt and sandwiched between the belt and additional layers, facilitates formation of a particularly effective upper layer. As such, the composite article, and each of the layers thereof, may be formed in a top-down manner, which is distinct from other methods to form this layer, such as in an exemplary conventional photoreactive composite material, like the SHEERFILL® EverClean material.

Subsequent dip casting processes can be undertaken to form other component layers of the composite article. For example, the core layer 105 can be formed through dip casting, using one or more particular dispersions having the desired components and additives to form the one or more layers making the core layer on the previously deposited upper layer. For example, a core layer 103 can be formed by forming a plurality of layers bonded to each other, wherein certain layers can include additives that are added to particular dispersions to achieve a desired property. Accordingly, the chemical components within two dispersions used to form the core layer 103 can be different from each other, depending upon the desired characteristics of each of the layers. It will be appreciated that the adhesive layer 101 can be formed in a similar manner.

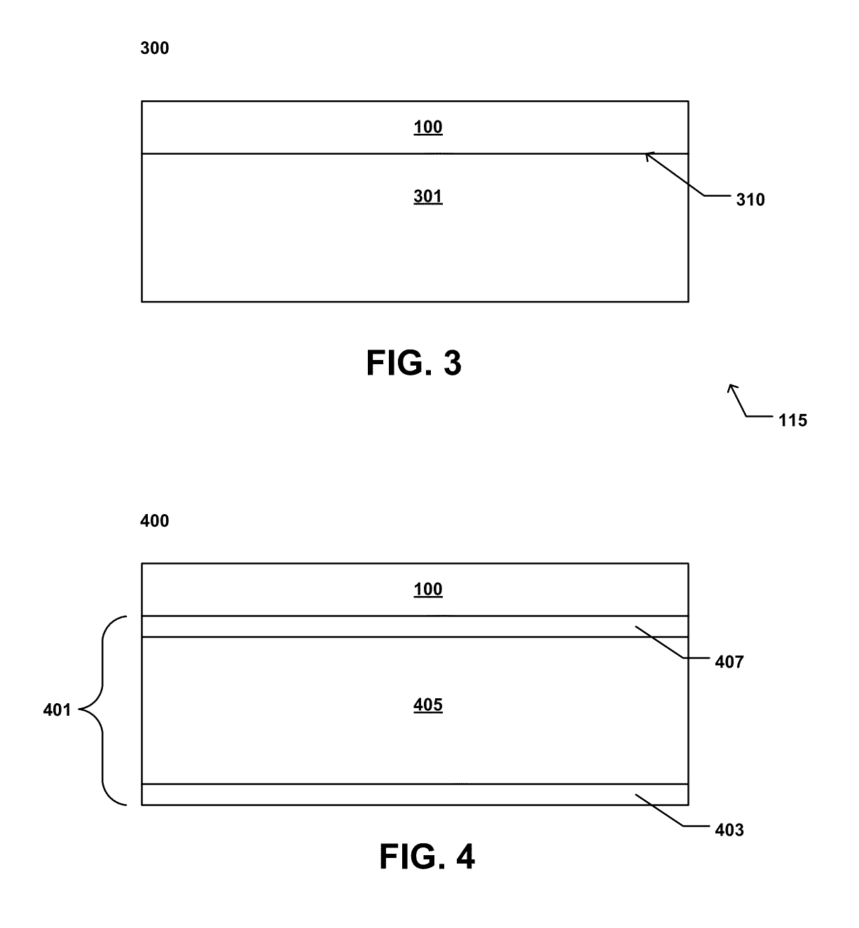

FIG. 3 includes a cross-sectional illustration of a composite structure in accordance with an embodiment. As illustrated, the composite structure 300 can include a base structure 301. Furthermore, the composite structure can include a composite article 100 overlying the base structure 301. In particular instances, the composite article 100 can be directly in contact with the base structure 301 and more particularly may be directly bonded to a surface of the base structure at the interface 310.

In accordance with an embodiment, the base structure 301 can be a structure utilized in various applications including the electronics industry, optics industry, electro optics industry, telecommunications, other communications including RF frequency communications, medical industry, architectural industry, and a combination thereof.

In particular instances, the base structure 301 can include a composite structure, including multilayered constructions of different types of materials. For example, certain composite structures can include a combination of natural and synthetic materials. Some composite structures can include a combination of one or more materials selected from the group of materials consisting of ceramics, glass, polymer, natural fibers, woven materials, non-woven materials, and the like.

In one embodiment, the base structure 301 can be a flexible material, such as a structural fabric. In fact, in certain instances, the flexible material can be a composite utilizing a woven or non-woven substrate material and one or more overlying or underlying materials. The overlying or underlying materials may be woven or non-woven materials. Exemplary flexible materials can include the materials described in U.S. Pat. Nos. 7,196,025; 5,357,726; and 7,153,792, the information of which is incorporated herein in entirety.

In certain other instances, the base structure 301 can be a rigid material. The rigid material can be a composite material, incorporating any of the materials described above. More particularly, some suitable rigid materials can include metals, metal alloys, ceramics, glass, polymers, foams, and a combination thereof.

FIG. 4 includes a cross-sectional illustration of a composite structure in accordance with an embodiment. As illustrated, the composite structure 400 can include a base structure 401. The base structure 401 can be a composite material incorporating a base layer 403, an intermediate layer 405 overlying the base layer 403, and an upper layer 407 overlying the intermediate layer 405. Moreover, the composite structure 400 can be formed to include a composite article 100 overlying the base structure 401. In particular instance, the composite article 100 can be in direct contact with the base structure 401. In more particular instances, the composite article 100 can be directly bonded to the base structure 401 and may be directly bonded to a surface of the upper layer 407 of the base structure 401.

In accordance with an embodiment, the base structure 401 can be a composite material. More particularly, the intermediate layer 405 can be a porous core material. The intermediate layer can include a material such as glass, ceramic, polymer, metal, metal alloy, natural material, woven material, non-woven material, and a combination thereof.

As illustrated, the porous core material of the intermediate layer 405 can be attached or combined with one or more materials. For example, the porous core material of the intermediate layer 405 can have an overlying and an underlying skin layer, as defined by the upper layer 407 and the base layer 403, respectively. The skin layer can be formed of a material such as a glass, ceramic, polymer, metal, metal alloy, natural material, woven material, non-woven material, and a combination thereof. In particular instances, the base layer 403 or upper layer 405 can be a skin layer that can include a composite material, particularly an impregnated material (i.e., “pre-preg material”). For example, the composite material can include a fabric or woven material that is impregnated with a non-woven material. In one particular example, suitable pre-preg materials can include woven fiberglass impregnated with a polymer. The polymer material can be thermoset or thermoplastic material.

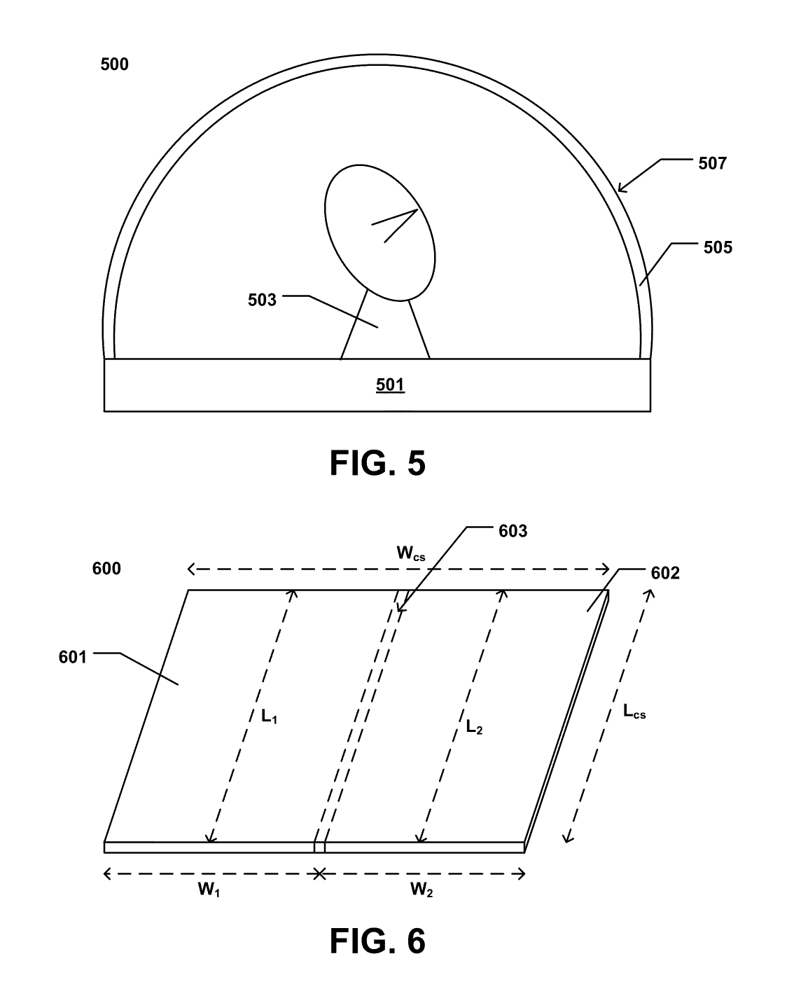

FIG. 5 includes an illustration of a transmitter/receiver structure in accordance with an embodiment. As illustrated, the transmitter/receiver structure 500 includes a transmitter/receiver assembly including a base 501, a transmitter/receiver assembly 503 attached to the base 501, and a cover 505 overlying the transmitter/receiver assembly 503. Notably, the cover 505 can provide the transmitter/receiver assembly 503 with protection from certain atmospheric elements and harsh environmental factors. According to an embodiment, the cover 505 can include a composite article 100 as described herein. Furthermore, the cover can include a composite structure including a base structure and a composite article as described in the embodiments herein (see, for example, structures described in FIGS. 4 and 5). It will be appreciated that the cover 505 can be formed such that the exterior surface 507 is made up of the composite article 100, and the exterior surface 109 of the upper layer 105 forms the exterior surface 507 of the entire cover 505.

FIG. 6 includes a perspective view illustration of a composite sheet in accordance with an embodiment. Notably, the composite sheet 600 includes a first composite article 601 coupled to a second composite article 602 at a joint region 603. The first and second composite articles 601 and 602 can include the features of any of the composite articles described herein.

According to a particular embodiment, the composite articles 601 and 602 include an upper layer comprising PFA, and a joint region 603 defined by a melt-flowed bond, such that the first and second composite articles 601 and 602 are bonded directly to each other at a melt-flowed seam defined by a chemical and/or mechanical bond. In particular instances, the joint region can be characterized by a diffusion bond, wherein chemical components of the first and second composite articles 601 and 602 diffuse into each other and form a mechanical or chemical bond. It will be appreciated, that the joint region can be formed by joining the sides of the first and second composite articles 601 and 602 in a particular manner and applying heat to the region until the material melts together, forming a melt-flow bond. Suitable temperatures can be in the range between about 250° C. to about 400° C., such as between about 300° C. to about 400° C., between about 325° C. to about 400° C., or even between about 330° C. to about 400° C.

Moreover, the joint region can be formed, such that at least one or more corresponding layers of the first and second composite articles 601 and 602 can be bonded to each other by a melt-flow bond. For example, the adhesive layers of the first and second composite articles 601 and 602 can be bonded together using a melt-flow bond, wherein sufficient temperature is applied to the joint region to cause melting and diffusion of the adhesive layers of the first and second composite articles 601 and 602. Alternatively, or in addition, the core layers of the first and second composite articles 601 and 602 can be bonded together using a melt-flow bond, wherein sufficient temperature is applied to the joint region to cause melting and diffusion of a portion or all of the core layer of the first and second composite articles 601 and 602. Alternatively, or in addition, the upper layers of the first and second composite articles 601 and 602 can be bonded together using a melt-flow bond, wherein sufficient temperature is applied to the joint region to cause melting and diffusion of the upper layers of the first and second composite articles 601 and 602.

As illustrated, the first composite article 601 can have a length (L₁) that extends parallel to the joint region 603. That is, the joint region 603 can extend along a length of the first and second composite articles 601 and 602.

According to one embodiment, the composite sheet 600 is a large area material. The composite article 601 can have a length of at least about 10 m, such as at least about 20 m, at least about 30 m, at least about 40 m, at least about 50 m, at least about 100 m, or even at least about 300 m Likewise, the second composite article 602 can have the same length (L₂) as the length (L₁) of the first composite article 601. Moreover, the composite sheet 600 can have a length that is the same as the lengths of the first and second composite articles 601 and 602.

The composite article 601 can have a width (W₁) of at least about 0.5 m, such as at least about 0.8 m, at least about 0.9 m, at least about 1 m, or even at least about 1.5 m. Likewise, the second composite article 602 can have the same width (W₂) as the width (W₁) of the first composite article 601. Moreover, the composite sheet 600 can have a width that is the sum of the sum of the width of the first composite article 601 and a width of the second composite article 602. It will be appreciated that while the composite sheet 600 is illustrated as being made of only the first and second composite articles 601 and 602, additional composite articles can be joined to form a composite sheet of the preferred dimensions.

The composite sheet 600 can have a primary aspect ratio defined as the length (L_{cs}):width (Wₜ) of at least about 2:1. In other embodiments, the primary aspect ratio can be greater, such as at least about 3:1, at least about 4:1, at least about 5:1, or even at least about 10:1.

The composite sheet 600 can have a secondary aspect ratio defined as the length (L_{cs}):thickness (T_{cs}) of at least about 100:1. In other embodiments, the secondary aspect ratio can be greater, such as at least about 500:1, at least about 1000:1.

### Example 1

Photoreactivity was determined by determining the color change of methylene blue as described herein. Three samples were formed according to embodiments herein to test the photoreactivity of the samples under various conditions, including conditions of forming composite sheets. Samples A, B, and C are formed of a PFA sheet comprising between about 10-40 wt % TiO₂. Sample A is tested according to the standard test and the change in color is measured as photoreactivity of about 31. Sample B is the same as Sample A, however after adding the dye, the sample is subject to heat to simulate forming processes, such as heating to form a joint region. The heating process includes holding the sample at a temperature of about 680° F. for 30 seconds. The color of the sample was again measured according to the test.

Sample C was made the same as Sample A, however after adding the dye, the sample is subject to heat to simulate forming processes, such as heating to form a joint region. The heating process includes holding the sample at a temperature of about 680° F. for 180 seconds. The color of the sample was again measured according to the test.; Table 1 depicts the measured data.

TABLE 1

| | Before Me Blue | | | After Me Blue | | | |
|---|---|---|---|---|---|---|---|
| Sample | L* | a* | b* | L* | a* | b* | Δ E |
| A | 54.07 | −1.325 | −9.23 | 35.693 | −4.756 | −34.378 | 31 |
| B | 53.97 | −1.403 | −7.92 | 36.493 | −7.015 | −29.338 | 28 |
| C | 53.653 | −0.345 | −3.91 | 46.728 | −7.424 | −13.872 | 14 |

As can be seen from Table 1, the photoreactivity of Sample A was quite good, having a value of 31. Despite undergoing significant heat treatment, Sample B maintains approximately 90% of the original photoreactivity as compared to Sample A (i.e., (28/31)×100%=90%). Sample C demonstrated a lower, but still satisfactory decrease in photoreactivity after prolonged

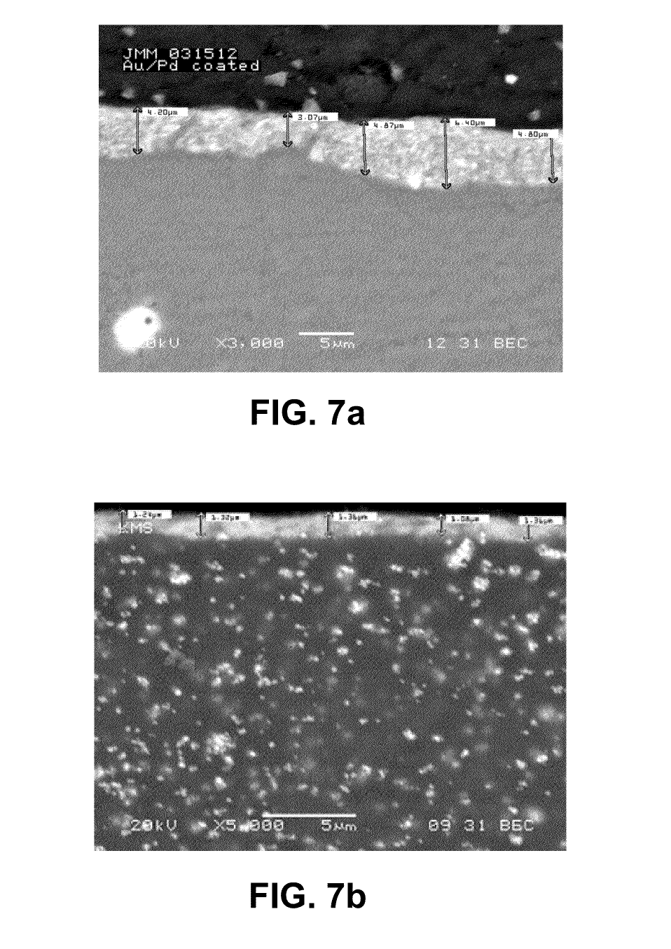

FIG. 7a depicts a SEM image of a coated fabric with titanium dioxide (TiO₂) as the photocatalytic material in the topcoat layer. As can be seen from the SEM image, the topcoat layer has a thickness ranging from 3.07 microns to 6.40 microns. From the brightness of the layer, it can be seen that the concentration of the TiO₂ in the topcoat layer is higher than in the fabric. Detailed analysis show that at least about 25% of the total area of the exterior surface of the topcoat layer is defined by photocatalytic material TiO₂. Also, it can be seen from the brightness of the topcoat layer that at least about 25 wt % is the photocatalytic material for the total weight of the topcoat. Moreover, it is shown that the concentration of photocatalytic material TiO₂ in the topcoat is greater than in the underlying fabric.

FIG. 7b depicts a SEM image of a cast film containing titanium dioxide (TiO₂) as the photocatalytic material in the film and in the topcoat layer and the film (white particles). As can be seen from the SEM image, the topcoat layer has a thickness ranging from 1.04 microns to 1.36 microns. From the brightness of the layers, it can be seen that the concentration of the TiO₂ in the topcoat layer is higher than in the film. Detailed analysis show that at least about 25% of the total area of the exterior surface of the topcoat layer is defined by photocatalytic material TiO₂. Also, it can be seen from the brightness of the topcoat layer that at least about 25 wt % is the photocatalytic material for the total weight of the topcoat. Moreover, it is shown that the concentration of photocatalytic material TiO₂ in the topcoat is at least 4% greater than in the underlying layer.

The foregoing embodiments describe features of composite articles, composite structures, and composite sheets for use in a variety of applications and environments. The composite articles include a combination of features that represent a departure from the state-of-the-art, including for example, particular layered structures, particular layer compositions, particular photocatalytic materials, effective positioning of photocatalytic materials, improved photoreactivity, surface roughness, smoothness and planarity of the upper layer, use and arrangement of composite structures including base structures and skin layer, large area composite sheet materials, and the like. Moreover, the method of forming the composite articles of the embodiments herein represents a departure-from-the-state of the art that facilitates the features of the composite articles, composite structures, and composite sheet materials described herein. Moreover, while certain state-of-the-art composites utilize non-melt formable materials to mitigate migration of photocatalytic material during processing, these concerns have been overcome through extensive research leading to the unique forming process.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description of the Drawings, with each claim standing on its own as defining separately claimed subject matter.

1. A composite article comprising:
a core layer; and
an upper layer overlying the core layer, wherein the upper layer comprises
perfluoroalkoxy polymer (PFA) and a photocatalytic material (PM), and wherein the upper layer comprising at least about 2% greater concentration per unit area of PM at an exterior surface of the upper layer compared to a conventional photoreactive composite material.

2. A composite article comprising:
a core layer; and
an upper layer overlying the core layer, wherein the upper layer comprises perfluoroalkoxy polymer (PFA) and a photocatalytic material (PM), and wherein the PM defines at least about 25% of a total area of an exterior surface of the upper layer.

3. A composite article comprising:
a core layer; and
an upper layer overlying the core layer, wherein the upper layer comprises
perfluoroalkoxy polymer (PFA) and a photocatalytic material (PM) consisting essentially of titanium dioxide (TiO₂) particles, wherein the titanium dioxide particles define at least about 25% of a total area of an exterior surface of the upper layer.

4-6. (canceled)

7. The composite article of claim 1, wherein the upper layer comprises at least about 4% greater concentration per unit area of PM at the exterior surface of the upper layer compared to the conventional photoreactive composite material.

8. The composite article of claim 1, wherein the upper layer comprises at least about 25 wt % PM for the total weight of the upper layer.

9. The composite article of claim 8, wherein at least 10% of the total content of PM present within the upper layer is present at the exterior surface of the upper layer.

10. The composite article of claim 1, wherein the upper layer consists essentially of PFA and PM.

11. The composite article of claim 1, wherein the PM comprises titanium dioxide.

12. The composite article of claim 11, wherein the PM consists essentially of titanium dioxide.

13. The composite article of claim 1, wherein the PM comprises a particulate material having an average particle size of not greater than about 1 micron.

14. The composite article of claim 13, wherein the particulate material comprises a morphology selected from the group consisting of elongated, needle-like, platelet, irregular, rounded, and a combination thereof.

15. The composite article of claim 1, wherein the upper layer has an average thickness (Tᵤₚ) not greater than about 10 times an average particle size of the PM.

16. The composite article of claim 1, wherein the upper layer is essentially free of a polytetrafluoroethylene.

17. The composite article of claim 1, wherein the upper layer is in direct contact with the core layer.

18. The composite article of claim 1, wherein the upper layer is bonded directly to a surface of the core layer.

19. The composite article of claim 1, wherein the core layer comprises a continuous layer of material.

20. The composite article of claim 1, wherein the core layer comprises a plurality of layers.

21. The composite article of claim 20, wherein at least one of the layers of the plurality of layers comprises a filler material.

22-107. (canceled)
